(19) United States
(12) Patent Application Publication
(10) Pub. No.: US 2013/0174480 A1
(43) Pub. Date: Jul. 11, 2013

(54) High raised garden bed planter

(71) Applicant: Douglas Leonard Gabelmann, Tweed (CA)

(72) Inventor: Douglas Leonard Gabelmann, Tweed (CA)

(21) Appl. No.: 13/694,501

(22) Filed: Dec. 7, 2012

(30) Foreign Application Priority Data
Dec. 8, 2011 (CA) 2000022483

(51) Int. Cl. A01G 9/02; B21F 29/02

(52) U.S. Cl. CPC A01G 9/02; B21F 29/02
USPC 47/65.5; 140/71 R

(57) ABSTRACT

A planter assembly o raise a garden bed to a height that eliminates or minimizes stoop labour is comprised of lightweight, flexible, materials with adequate tensile strength as well as a rigid element with adequate compressive strength.

Flexible wire mesh is formed into a perimeter frame of pre-determined width, length and height in combination with rods and wire.

A textile lines the perimeter frame, providing a barrier impervious to soil. The textile encloses the top horizontal wire of the mesh within a hem held fast by wire and is thereby restrained. A band of the textile, sufficiently wide to be held to the ground by the placement of soil, extends from the base of the perimeter frame towards its middle.

Wire is also used as crossties to enable the lateral earth pressure pushing against one side to resist the lateral earth pressure pushing against the side opposite.

### BACKGROUND

1. Field

The technical field of this invention relates to planters for raised garden beds, specifically to planters high enough to eliminate or minimize stoop labor, as may be preferred.

2. Prior Art

An important part of vegetable production is not amenable to mechanization. Stoop labor is required. Meeting this requirement is increasingly difficult, as the potential labor pool ages and its physical fitness declines. Getting older and/or less fit is also affecting the capacity of people to continue home gardening and community gardening.

Raised beds are increasingly common in commercial agriculture and in home and community gardening. In comparison to growing plants at grade, raised beds offer better water and cold air drainage, earlier soil warmth, which promotes earlier plant growth, and reduced fertilization and weed control needs. Efficient drip irrigation systems work well in raised beds.

But the height of most raised beds only slightly reduces how much people have to stoop when the crop or task is not amenable to mechanization or the use of long-handled tools. Most raised beds do not have containment structures. And without a containment structure, raised beds are subject to erosion and need to be reformed regularly. Erosion also creates a disincentive for practices that over the medium and long term improve the productivity of the soil.

The advantages of raised beds have led to the development of a variety of containment structures, called planters. However, planters are rarely used in commercial agriculture due to their cost. When constructed to a height that eliminates stoop labor, the planters of the prior art are prohibitively expensive for farmers and too costly for most gardeners.

Planters as represented in the prior art typically rely on the pre-existing rigidity of structural materials like wood, stone, concrete, or plastic facsimiles of same, to resist the lateral earth pressure that results when gravity interacts with the internal friction of the soil mass. These construction materials are bulky and costly. Except for the materials made of synthetic polymers sometimes employed, they are also very heavy, a factor adding to transport and construction costs. In its wooden embodiments, the structural integrity of the prior art is degraded by biological activity engendered by the moist soil required for growing the plants of interest to farmers and gardeners. In the prior art, the replacement of construction materials is difficult and/or costly.

Accordingly, there is a need for planters that are lightweight and affordable, durable, easy to construct and maintain, and high enough to eliminate stoop labor.

### SUMMARY

In an embodiment of the present invention, the problem of cost inherent in the prior art is overcome by constructing a perimeter wall in large part from inexpensive, flexible materials with latent rigidity and in part from inexpensive, sufficiently rigid rods with adequate compressive strength. These materials enable the efficient and effective use of crossties.

Flexible wire mesh is formed to fit a rectangular perimeter frame of pre-determined width, length and height. Rods held against the inside corners of the formed mesh are attached to other rods fixed as corner posts at a predetermined spacing outside the formed mesh. Other rods brace these corner posts. Wire is cut to length to use to tie the inner and outer rods and for other attachments. Other rods are interlaced vertically through the horizontal wires of the mesh. These rods are placed so that they push the bottom horizontal wire down, the top horizontal wire up, and increase the distance the other horizontal mesh wires travel between fixed corner posts, whereby the rigidity of the perimeter frame is increased.

A textile with adequate vertical and horizontal tensile strength lines the perimeter frame, providing a barrier impervious to soil. The textile encloses the top horizontal wire of the mesh within a hem held fast by wire. A narrow band of the textile is placed as an underlay at right angles to the perimeter wall towards the interior of the embodiment at its base.

Wire is also cut to length to use as crossties to hold opposite side walls straight and upright. Crossties enable the lateral earth pressure pushing against one side to resist the lateral earth pressure pushing against the side opposite.

### BRIEF DESCRIPTION OF THE DRAWINGS

FIG. 1 is a perspective view of a first embodiment of my invention.

FIG. 2A shows a perspective view of an arrangement of corner posts and braces.

FIG. 2B shows a perspective view of a formed wire mesh as it would appear if it could be isolated from the perimeter frame shown in FIG. 2C-1.

FIG. 2C-1 shows a perspective view of a perimeter frame.

FIG. 2C-2 shows an end view. The angled braces are not displayed.

FIG. 2D shows a perspective view of a textile liner as it would appear if it could be isolated from the perimeter frame shown in FIG. 2C-1.

FIG. 2E shows a perspective view of a first embodiment as it appears prior to the placement of soil.

FIG. 2F shows a perspective view of a first embodiment with the soil 600 in place.

FIG. 2G illustrates plant life in a first embodiment of my invention.

DRAWINGS—Reference Numerals

| | |
|---|---|
| 110—corner post—rod | 420—textile liner |
| 112—angled brace—rod | 420-1—underlay—part of textile |
| 114—level brace—rod | 420-2—hem—part of textile |
| 116—temporary guy—assembly tool | 510—optional temporary post— |
| 210—mesh clamping rod | assembly tool |
| 220—wire mesh | 516—optional temporary spacer— |
| 310—tensioning rod | assembly tool |
| 410—liner clamping rod—optional | 520—crosstie—wire |
| assembly tool | 600—soil |
| | 700—plants |

### DETAILED DESCRIPTION ACCORDING TO A FIRST EMBODIMENT OF THE PRESENT INVENTION

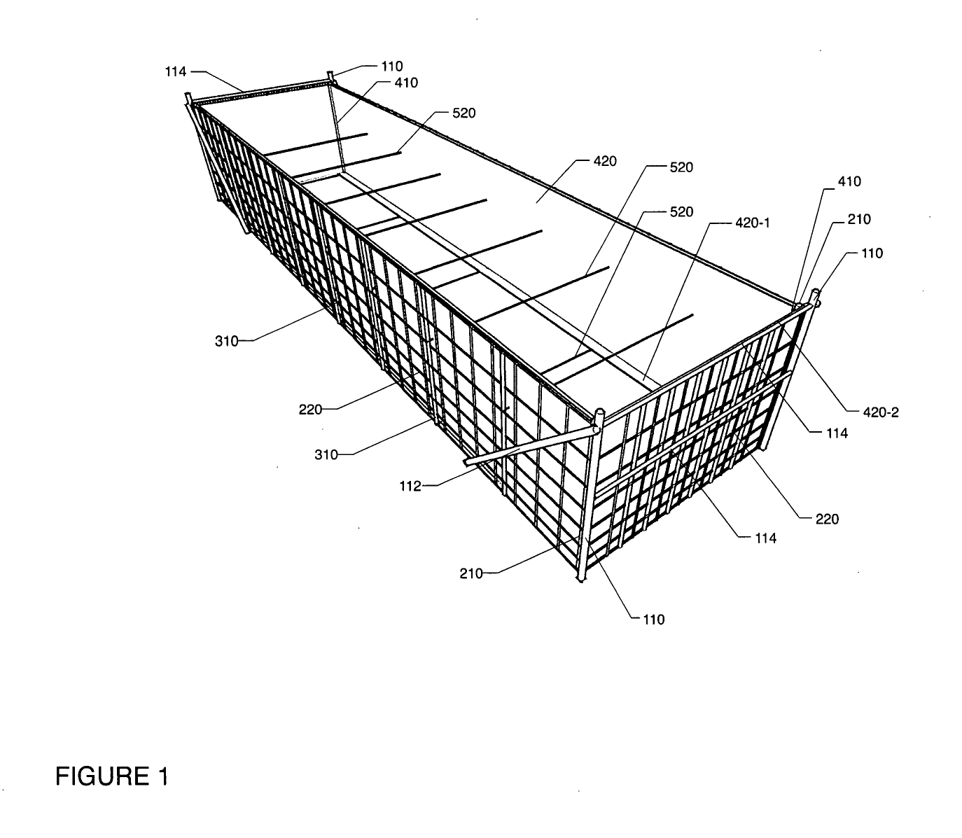

FIG. 1

FIG. 1 shows a perspective view of a first embodiment of the present invention. Wire mesh 220 forms a rigid, upright, rectangular perimeter frame of pre-determined width, length and height in combination with rods and wire. Mesh clamping rods 210 fixed to the inside corners of the wire mesh 220 are attached to other rods fixed as corner posts 110 at a predetermined spacing outside the wire mesh 220. Angled braces 112 and level braces 114 support the corner posts 110. Wire, not shown, is cut to length to use to tie the inner and outer rods and for other attachments. Tensioning rods 310 are placed over the bottom horizontal wire and under the top horizontal wire of the wire mesh 220 are interlaced vertically through the intervening horizontal wires of the mesh 220. A textile 420 lines the perimeter frame making it a wall. The textile encloses the top horizontal wire of the mesh within a hem 420-2 held fast by wire. A narrow band of the textile is placed as an underlay 420-1 at right angles to the perimeter wall towards the interior of the embodiment at its base. Crossties 520 are fixed to opposite side walls.

The first embodiment forms a rectangle in a plan view, wherein the end walls, or ends, are the width wise walls and the side walls, or sides, are the length wise walls. An embodiment could be a square in a plan view. The present invention can also be embodied in other forms.

The height of the first embodiment is somewhat higher than a standard dining table. An embodiment can be made higher or lower. The width of the first embodiment is approximately twice the depth of a normal kitchen counter. This width permits access to the middle of the top surface with minimal strain. The present invention can be embodied in other widths.

This description of the width and height of the first embodiment might suggest that a preferred length is indicated by the relative dimensions of FIG. 1 and other Figures. This is not the case; there is no single preferred length, approximate or otherwise. The length of the embodiment shown in FIG. 1 and other Figures is solely for illustrative purposes. A preferred length is affected, inter alia, by a consideration of the efficiency of movement around an embodiment and by the availability of reasonably level ground.

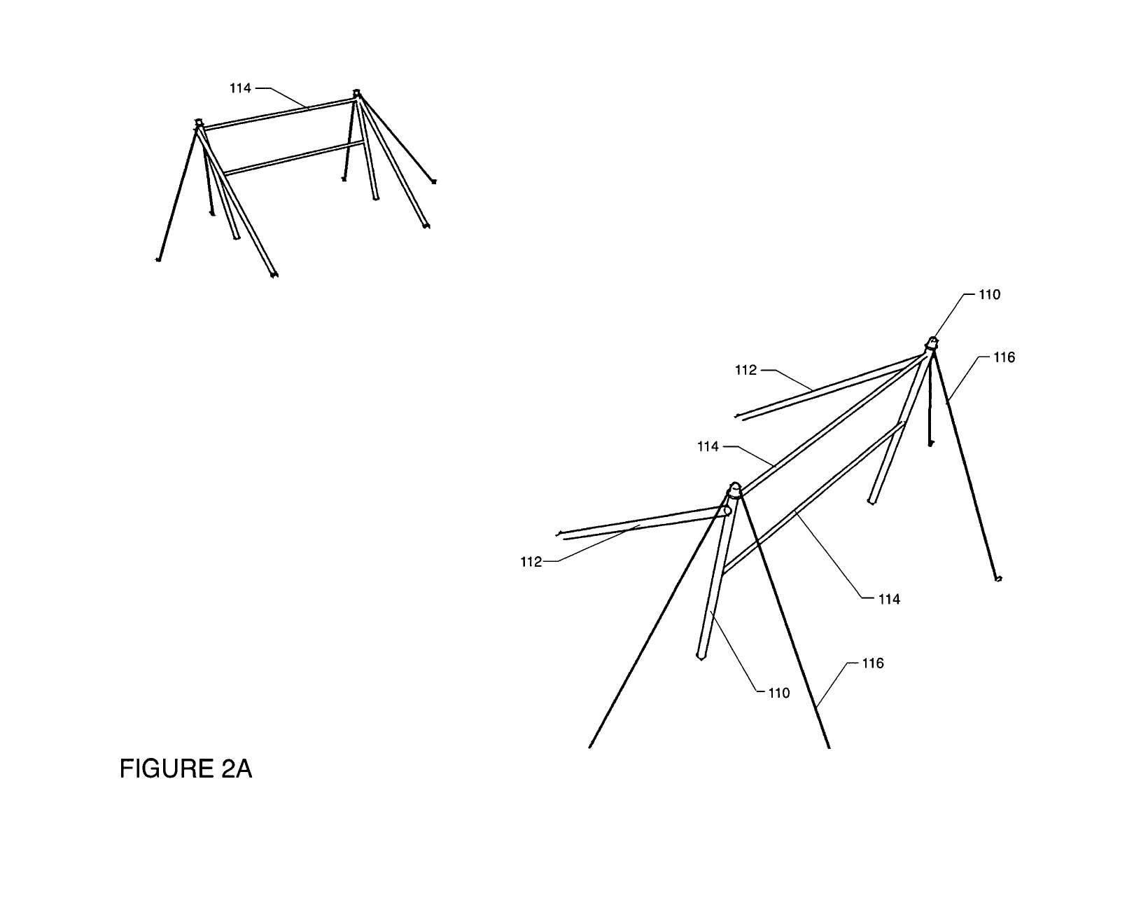

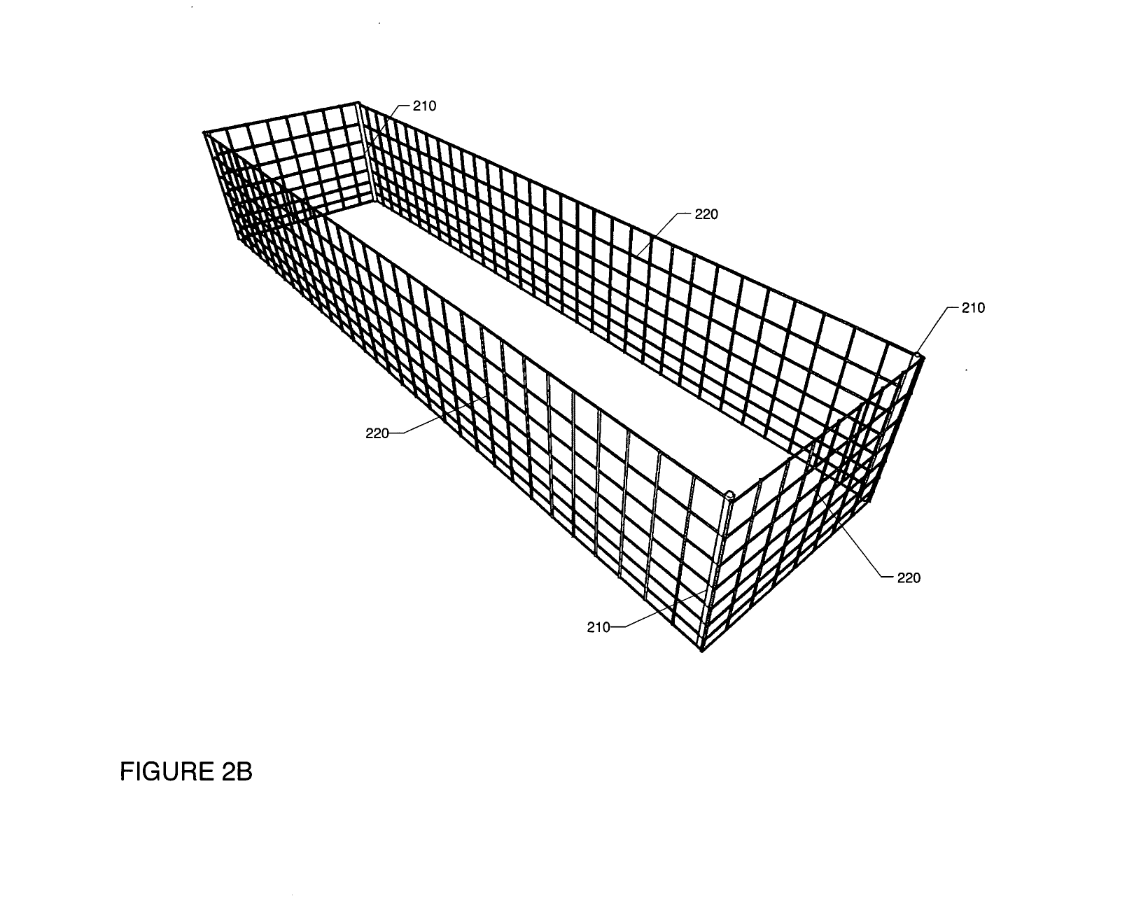

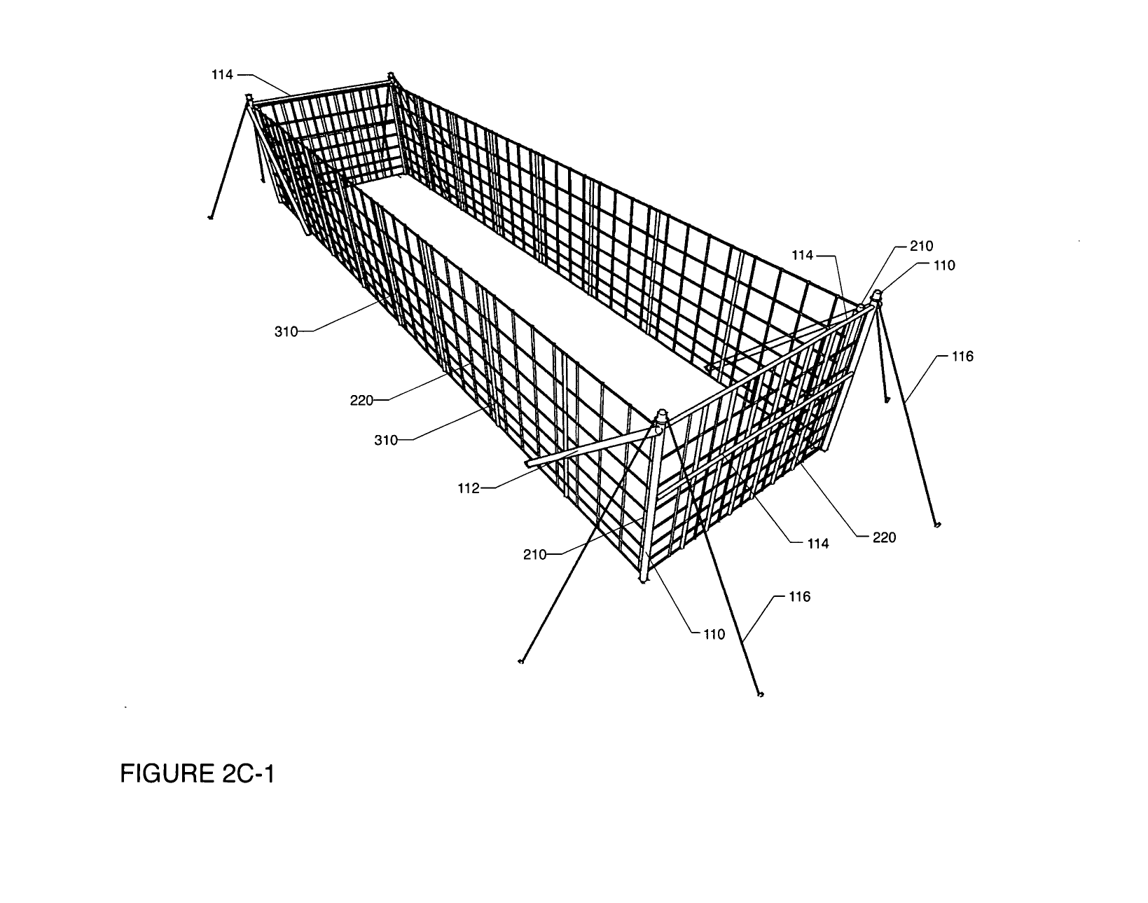

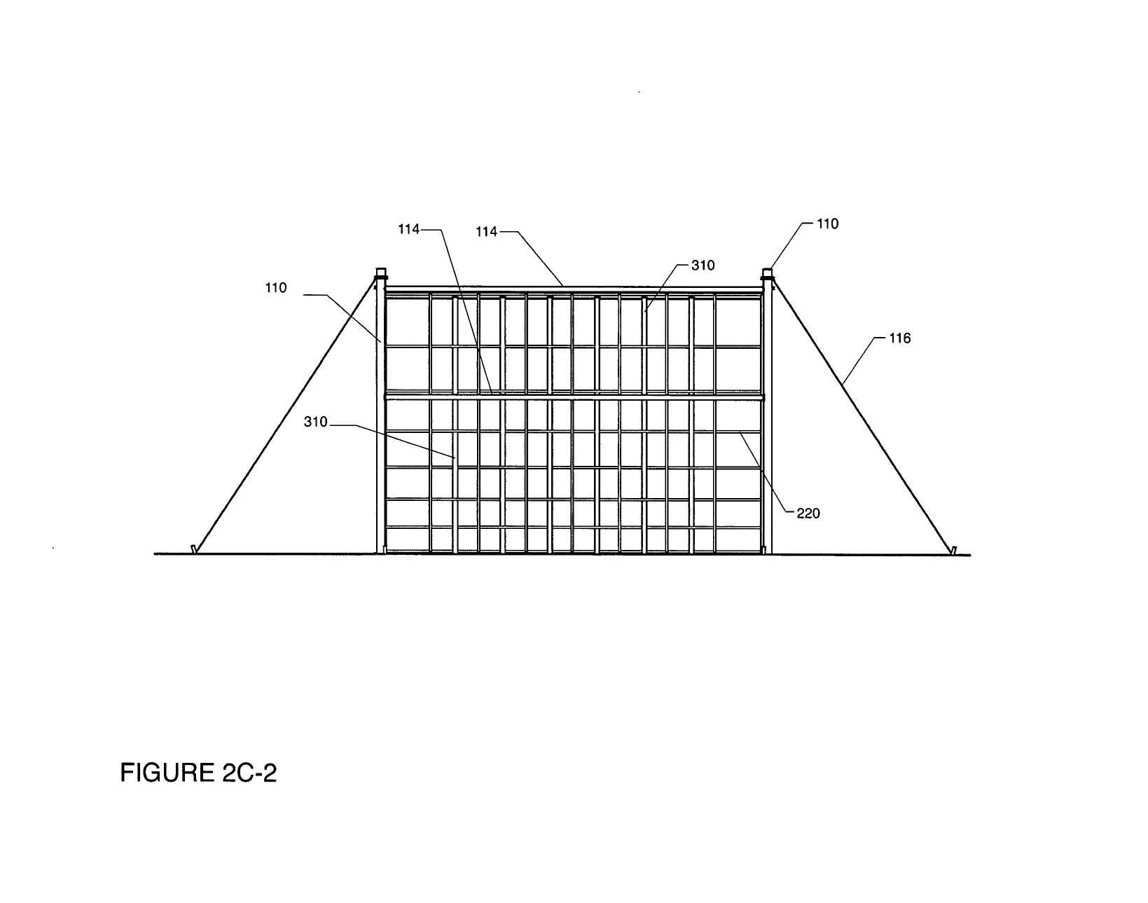

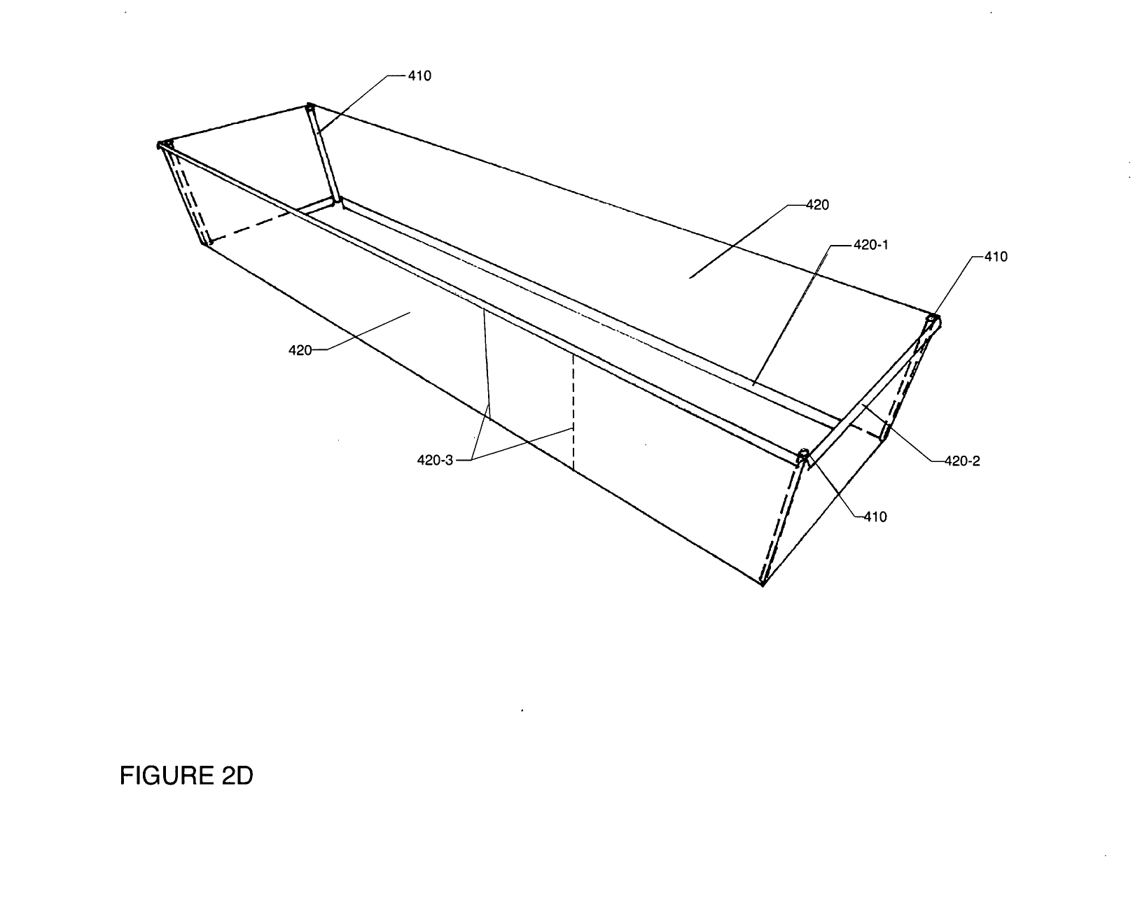

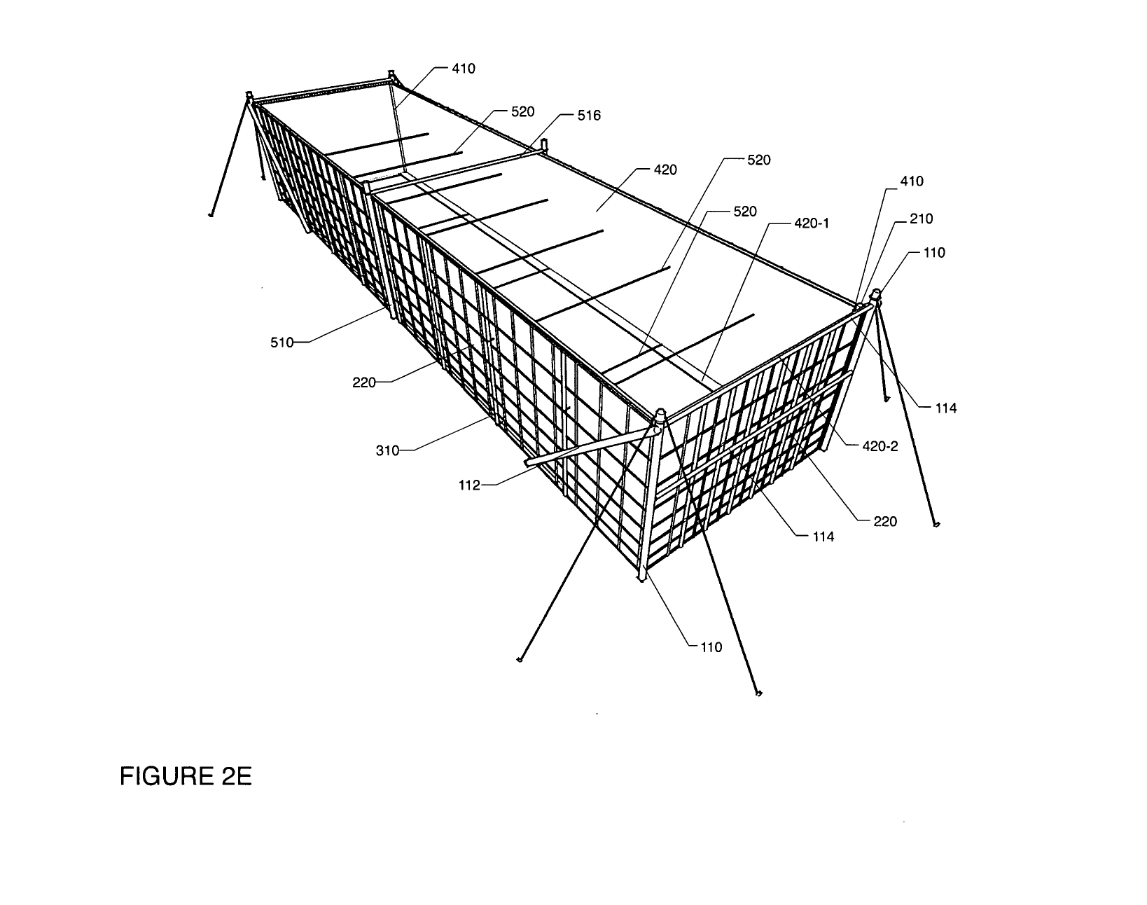

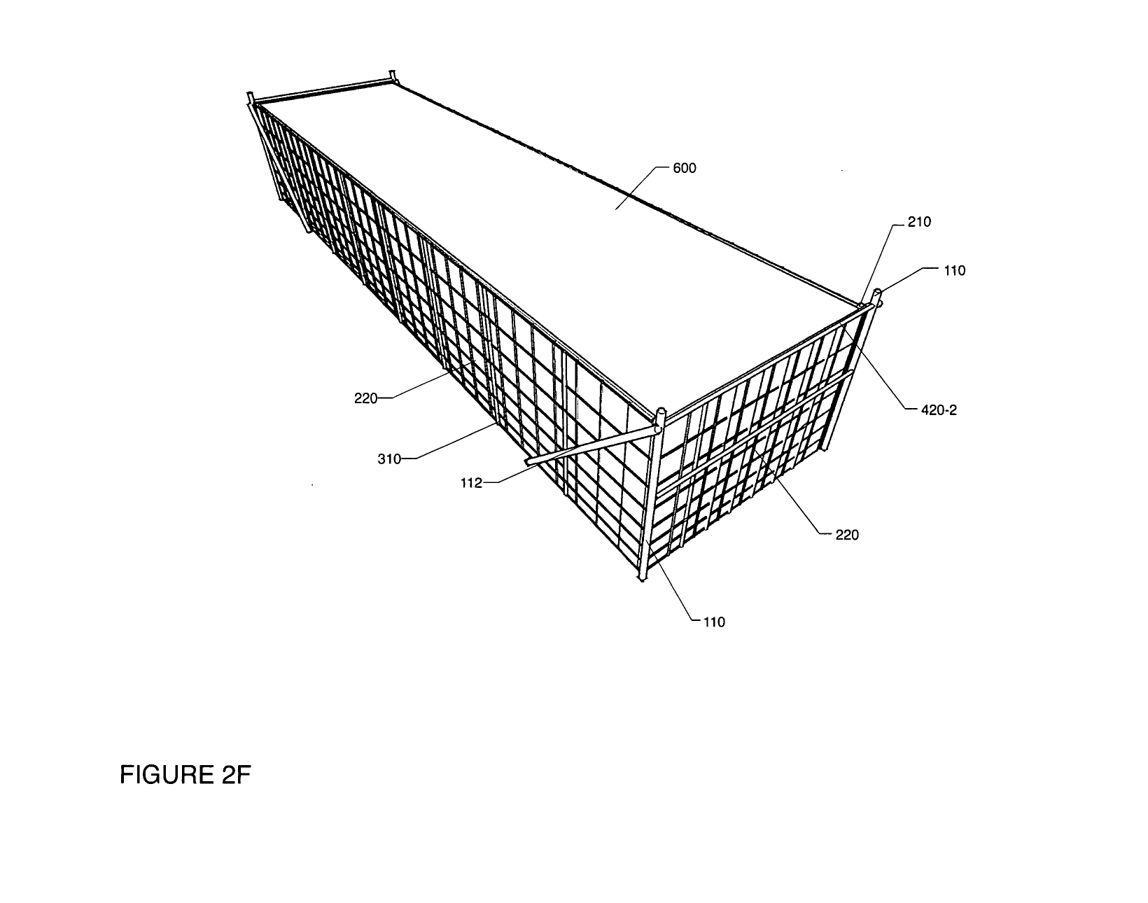

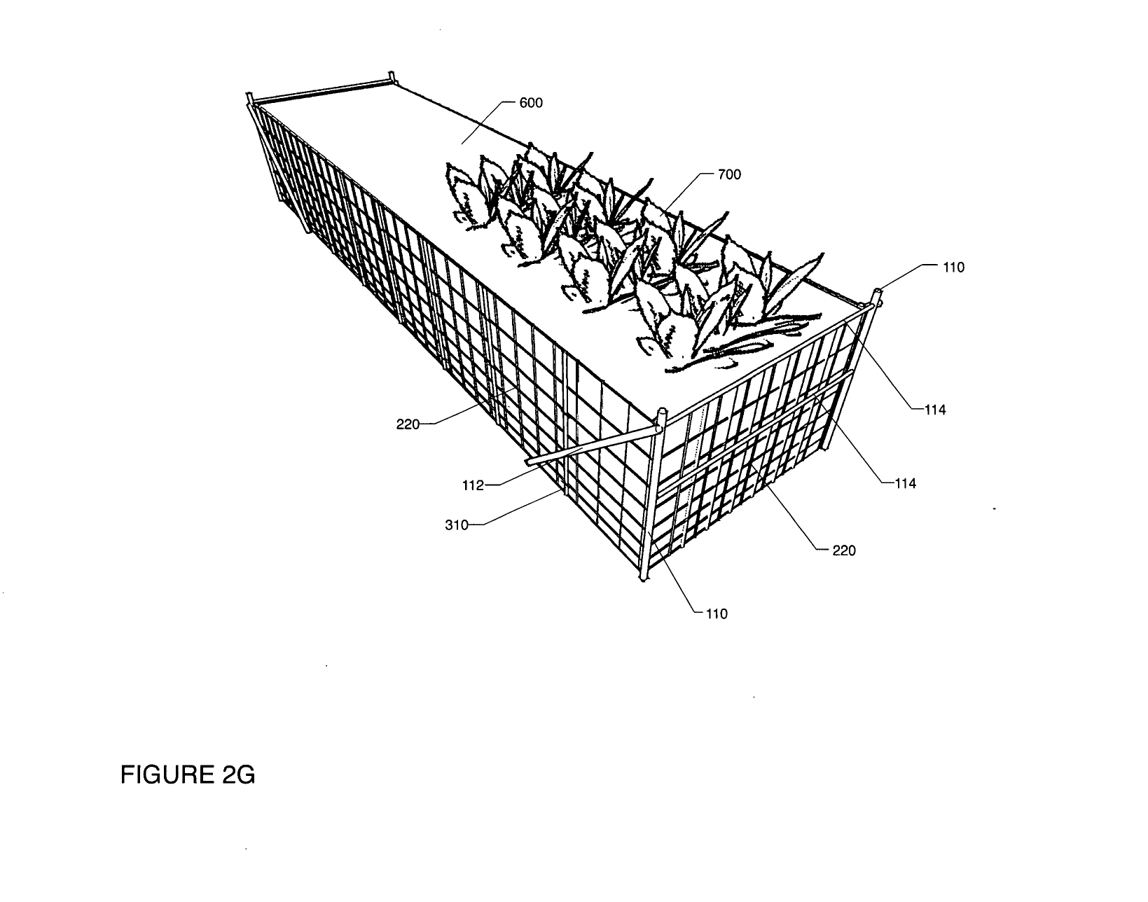

The number of horizontal and vertical wires in the mesh 220 shown in FIG. 1, and in other Figures, does not indicate a necessary number of either horizontal or vertical wires per a given distance. Several factors influence the selection of wire mesh. The amount of force exerted by lateral earth pressure is necessarily considered. Cost and durability are important factors. Weight and workability are of concern and these qualities are affected by the number of wires and their gauge or gauges. The spacing of the vertical mesh wires needs to accommodate the tensioning technique described below in the discussion of FIG. 2C-1. Graduated spacing of horizontal wires, wherein the distance between them decreases with depth, is advantageous. The tensile, trapezoidal and burst strengths of a textile are factors when considering mesh dimensions. In light of these criteria, graduated, Class 3 galvanized, high tensile, field fencing is used in the first embodiment. Embodiments of the current invention can use other mesh.

Throughout this description a horizontal wire refers to a length wise wire of a wire mesh, and a vertical wire refers to the width wise wire of a wire mesh.

FIG. 1 and other Figures show a quantity of tensioning rod 310. The quantity shown does not necessarily correspond to what will be needed to attain an adequate level of rigidity in the sides and in the ends of a perimeter frame of any dimension. The quantity of tensioning rods 310 shown in FIG. 1 and other Figures is approximately the number required when the first embodiment is assembled according to a method described in the discussion of FIGS. 2A to 2F. In any embodiment of the current invention the quantity of tensioning rods may vary from one end to the other and from one side to the other.

In FIG. 1 and other Figures, the corner posts 110 and the angled braces 112 are shown to have a larger diameter than the other rods. It is not necessary that this be the case. I contemplate that the rods this embodiment uses are constituted of bamboo and are of substantially similar diameter, although other materials are also suitable and mix of substantially different diameters is also suitable. In any normal bundle of commercially available bamboo rods of nominally the same diameter, there will be variance in the actual diameters, between rods and along the length of each rod. The most advantageous use of the larger diameter bamboo rods is as corner posts and angled braces and the Figures are meant to draw attention to this. I contemplate that the bamboo rods of this embodiment will range in diameter from 24 mm to 30 mm. These rods are sold commercially as one inch rods.

FIG. 1 shows a plurality of crossties 520. In the first embodiment, the crossties are at two levels. A lower level is on the ground. The upper level is more than mid way from the ground to the top, but deep enough to avoid tools used in gardening activities. The upper level corresponds to the height of a horizontal mesh wire. This correspondence is useful, but not necessary.

The quantity of crossties 520 shown in FIG. 1 and in other Figures does not necessarily correspond to what is needed. The quantity of crossties shown is approximately the number required when the embodiment is assembled according to a method described in the discussion of FIGS. 2A to 2F. The quantity of these parts that is required will be affected, inter alia, by the expected lateral earth pressure of the soil mass to be contained by an embodiment, the tensile strength of the wires of the mesh and of the crossties, and the rigidity of the perimeter frame prior to their installation. Using rods to distribute pressure on the sides will also affect the number of crossties required. As the case for any structure bearing loads, it is advisable to provide some redundant strength.

Except for wire used as crossties, wire used for attachments is not shown in FIG. 1 or other Figures. Wire used for crossties and other attachments will have adequate tensile strength and durability while being sufficiently flexible to be bent by a person of reasonable strength. I contemplate using 14 gauge, high tensile, Class 3 galvanized wire, but other wire can also be used. All the wire employed in any embodiment can be cut from a single, predetermined length of wire.

FIG. 1 shows a textile liner 420 on the inside of a perimeter frame comprised of rods, wire mesh and wire. I contemplate using a textile constituted of UV treated, woven polypropylene, known commercially as ground cover. Other textiles can also be used.

The connections between the parts of my planter are seen more clearly in FIGS. 2A to 2F. Each of these Figures shows a perspective view, except for FIG. 2C-2, which shows an end view. The method of assembly disclosed in this discussion is not the only method to assemble an embodiment of the present invention. It can be expected that persons knowledgeable in the art will improve the method of assembly.

FIG. 2A

FIG. 2A shows an arrangement of corner posts 110 and braces 112 and 114, as well as guys 116. The corner posts 110 are embedded in level or near-level ground at a pre-determined spacing. This embedment need only be sufficiently deep to stop any lateral movement of the corner posts at ground level. After the soil is placed in the embodiment, the embedment becomes redundant and any deterioration of the post below grade is inconsequential. A method to embed corner post is to drive a pointed steel bar vertically into the ground to a pre-determined depth, remove it, and place the corner post in the hole. Alternatively, the holes can be made with a small bore auger.

The corner posts 110 reach a height above the ground that is greater than the width, or height as it becomes, of the wire mesh. The extra height is to allow for levelling of the top of the perimeter frame in the case of uneven ground.

The length of the level braces 114 is equal to the pre-determined width wise distance between the corner posts at ground level. The level braces 114 help maintain the plumb of the corner posts 110. To maintain the pre-determined width of the embodiment, they are positioned so that their ends butt against the corner posts 110. Level braces 114 are installed at two heights. The lower brace 114 is at a height approximately equal to the midpoint of the predetermined height of the planter. This brace 114 reinforces the rigidity of the ends of the perimeter wall. The higher level brace 114 is placed at approximately the predetermined height of the embodiment and helps maintain the integrity of the upper end corners, especially against accidental blows.

The angled braces 112 are fastened to the corner posts 110 at or somewhat below the predetermined height of the planter. The angled braces are positioned outside of the corner posts and outside of the mesh 220 at the sides of the planter. The angled braces help maintain the plumb of the corner posts 110. The angled braces also help maintain the integrity of the upper end corners of the planter against accidental blows. By tying each angle brace 112 with wire from a point along the half of its length closest to the ground back to the base of the corner post, the angle brace is made more effective.

A method to attach the braces 112 and 114 to the corner posts 110 is to drill holes'through the rods at appropriate places and then thread wire through the holes to make an attachment. It can also be effective to loop wire around rods and fasten tightly.

The guys 116 are assembly tools and are removed after soil is placed in the planter. Theoretically, they are not required, but practically they speed assembly. They are needed if assembly occurs during windy conditions. A guy 116 comprises wire or other material and a short rod embedded in the earth in the manner of a tent peg. Guys are placed in line with the length and with the width of an embodiment. Guys help the braces 112 and 114 hold the corner posts perpendicular until soil is placed. Guys can be tested by forcefully pulling each post into the length and into the width of the planter and verifying plumb.

FIG. 2B

FIG. 2B shows a formed wire mesh 220 as it would appear were it possible to abstract it and four clamping rods 210 from the first embodiment of the present invention. The wire mesh is formed in the following way:
Two sections of wire mesh, each slightly longer than half of the predetermined perimeter length of the first embodiment, are obtained. When making length wise measurements of wire mesh, the mesh is placed under modest length wise tension.
Two right angle corners are made in each section of mesh. To begin, all of the length wise wires are bent at an equal distance from an end of a section. This distance from the end of a section to the bend is slightly more than half of the pre-determined, width wise distance between corner posts. Then the wires are bent near the other end of the section. The distance between the bends of a section corresponds to the pre-determined, length wise distance between the corner posts, less a slight amount. This slight amount may depend on the wire mesh selected.

In the case of the mesh used in the first embodiment, it is in the approximate range of 0.4% of the lengthwise distance between corner posts. The operation is then repeated for the other section of wire mesh.

When making right angle bends in the mesh to form corners, care is taken to ensure that the graduated horizontal wires of the mesh will meet when the two sections of wire mesh are later joined. If the mesh used does not have graduated horizontal wires, this is not a concern.
A mesh clamping rod 210 is attached to the inside of each of the two corners on each section of mesh. The length of each of the four rods is greater than the width of the mesh. When attached, the rods do not project substantially beyond the bottom horizontal wire of the mesh, but can project beyond the top horizontal wire.

The rod 210 can be effectively held in a corner in the following way. A rod is placed so that it is in contact with each of the bends of each of the horizontal mesh wires. A wire of suitable length is looped around a horizontal wire on both sides of the corner bend. The rod is between the bend of the horizontal wire and the short looped wire. The ends of the looped wire are then twisted tightly until this looped wire and the bent horizontal wire grip the now enclosed clamping rod 210. This process is repeated for all the horizontal wires and for all clamping rods.

FIG. 2C-1

FIG. 2C-1 shows a perimeter frame of the first embodiment of the present invention.

As described previously, the wire mesh 220 is first formed in two sections and each section has two corners and an attached clamping rod 210 in each corner. In the first embodiment the perimeter frame is made in the following way.
A section of wire mesh is aligned with two length wise corner posts 110 such that the bent ends of the section of mesh are directed width wise towards the other two corner posts. One clamping rod 210 is brought tightly against a corner post 110 with only the mesh wires separating the two rods. The two rods are firmly attached with wire at several heights including near ground level and near the top horizontal wire of the mesh. There are sufficient attachments to effect a strengthening of the corner post. The corner posts are supported by guys 116.
The other clamping rod 210 of the same section of wire mesh is now pulled forcefully to the opposite length wise corner post and is attached in the same manner as the first clamping rod. This operation is made easier with the assistance of a one hand clamp. The clamp is first positioned near the bottom of the corner post 110 and near the bottom of the mesh clamping rod 210. The clamp is then tightened bringing the post 110 and rod 210 together and they are attached with wire below the clamp and above the clamp. The clamp is repositioned higher up and the attachment of rod 210 to post 110 is repeated as before. This operation is repeated again until the two rods are held together tightly along their length. If the mesh has been correctly measured in relation to the distance between length wise corner posts, the mesh between the two corner posts will be taut.
Care is taken to ensure that the corner posts remain perpendicular and that the top horizontal wire is reasonably level.
The second section of mesh is installed in the same manner. Care is taken that both sections are reasonably level with each other.
With both sections of mesh attached at both ends to corner posts, the ends of the mesh are now joined. Because each section of wire mesh was slightly longer than half of the perimeter length of the first embodiment, the horizontal wires at the ends of a section will overlap the horizontal wires of the ends of the other section. It may be necessary or advantageous to trim the length of an end of one section or both sections of mesh. A simple way to join same level horizontal wires is to form a loop with one and then pass the other through that loop, pull it back until taut, and then twist it around itself. Other means to join wires are known in the fencing industry.

The completion of the tasks described above will result in a perimeter frame that is reasonably but insufficiently rigid. The rigidity of the perimeter frame is augmented by increasing the distance travelled by the horizontal wires between corner posts and by stretching the vertical wires. This is accomplished by the use of a plurality of tensioning rods 310. The tensioning rods are trimmed to a length equal to or very slightly longer than the nominal width of the wire mesh. Each tensioning rod 310 is interlaced vertically in the wire mesh 220. Adjacent horizontal wires between the top and bottom wires are on alternate sides of each rod. The bottom end of the rod is centered over the bottom horizontal wire. The top horizontal wire is pulled up with some effort and centered on the top end of the rod. Adjacent tensioning rods are placed on opposite sides of the same horizontal wire. Normally one or several vertical mesh wires will separate adjacent tensioning rods.

Because tensioning rods 310 are also used in conjunction with crossties 520 as described below in the discussion of FIG. 2E, they are initially spaced approximately 600 mm from each end and from each other along the whole length of each side. In this configuration of tensioning rods 310, crossties 520 will be perpendicular to the sides and parallel with the ends. On the ends, tensioning rods are normally spaced closer together, as is seen in FIG. 2C-2.

Tensioning rods 310 are added until ends and sides are sufficiently rigid. Sides, especially, are made equally rigid, or close to it.

FIG. 2C-2

FIG. 2C-2 shows an end view of the first embodiment. The quantity of tensioning rods 310 in either end of any embodiment may vary from the quantity shown.

FIG. 2D

FIG. 2D shows a textile liner 420 in isolation from the perimeter frame shown in FIG. 2C to which it is attached and which it lines. The textile is preferably a continuous sheet that is overlapped and joined at its ends. It is not necessary that the textile be continuous as several lengths could be overlapped and joined together. FIG. 2D also shows four liner clamping rods 410. A clamping rod 410 is a tool that may make assembly easier, especially in the event of wind during assembly. Clamping rods 410 can be removed after soil is placed or left in place to deteriorate.

In the first embodiment textile of pre-determined length, width, and weight is extended around the interior of the perimeter frame until it overlaps itself. The width of the textile is sufficient to allow an underlay 420-1 and a hem 420-2. An underlay 420-1 approximately 75 mm wide is sufficient. A hem approximately 25 mm wide is sufficient.

The hem 420-2 provides a means to attain adequate horizontal tautness in the textile liner 420 because the top horizontal wire of the wire mesh 220, which it surrounds, is interrupted along its length by the ends of vertical mesh wires and tensioning rods 310. These keep the hem from sliding horizontally. The underlay 420-1 and the hem 420-2 together provide a means to make the textile liner 420 vertically taut as the rising level of soil holds the textile to the ground and removes slack by pushing the liner into the mesh. A method to install the textile liner is as follows.
A roll of textile in pre-determined dimensions is held vertically against the inside of the perimeter frame and partially unrolled. The beginning of the textile liner 420 is preferably, although not necessarily, placed against a side of the perimeter frame, as is indicated by the dark line of 420-3 in FIG. 2D. Approximately 25 mm of the top edge of the liner is folded over the top horizontal wire and down the outside of the perimeter frame. Lengths of wire are used in the manner of basting a seam to attach the folded edge to the body of the liner forming a hem 420-2 around the top horizontal wire. Ordinary clothes pegs or equivalent devices can be used to temporarily hold the liner in place as the formation of the hem advances, although they are not necessary. Wire staples can be used instead of using wire in the manner of thread.
The textile is extended under tension and a hem formed until the textile lines the perimeter wall on both sides and both ends. The textile is extended until it overlaps itself and the hem is doubled. This is shown in FIG. 2D, wherein the dark line of 420-3 indicates the beginning and the dashed line the end of the textile liner 420.
The overlapped ends of the textile liner 420 are joined with a wire threaded vertically from near the top to near the bottom of the perimeter wall in the manner of basting a seam. The wire is pushed back and forth through the overlapped liner to form a seam.
In each corner it can be useful, especially in windy conditions, to install a liner clamping rod 410 from ground level to the top of the mesh 220. The clamping rod 410 is held in place with a wire near bottom and a second wire near top. Each wire is sufficiently long to encircle the liner clamping rod 410, the mesh clamping rod 210 and the corner post 110. One end of a wire is pushed through the liner on a side of the rod 410 and the other end on the other side of the rod 410. The two ends are tied with a twisting action on the outside of the post 110. The wire and the rod 410 can be removed after soil placement.

A textile liner 420 of sufficient strength needs only one layer to make the perimeter frame of mesh and rods into a perimeter wall that will retain soil. The protection provided to the textile by UV inhibitors can be augmented by means as simple as growing leafy plants, such as creepers, on the exterior of the perimeter frame. Some gardeners may prefer to install a skirt made of dried grass or other material to serve as a sunscreen.

It is also possible to reasonably align the lifecycle of the textile with the lifecycle of the wire mesh by using more than one layer of textile. In this case, an outer layer will screen an inner layer. To install a double layer it is preferable, although not necessary, to roll out a single sheet of textile of adequate length. The installer proceeds as described above for the first layer, except that the hem attachment can be more sparing. The second layer is laid against and over the first layer and the hem is formed and ends joined as described previously.

FIG. 2E

FIG. 2E shows the perimeter frame of FIG. 2C with the textile liner 420 of FIG. 2D attached. FIG. 2E also shows crossties 520. In the first embodiment crossties 520 are placed at two levels: ground level, and at a level more than half way from ground level to the top of the perimeter wall. Crossties are kept below the depth of normal cultivation of the soil. Crossties 520 keep the perimeter frame at its predetermined width. Opposing, approximately equal, lateral earth pressures are neutralized by their connection through the upper level crossties.

Upper level crossties 520 are attached in a manner that allows for their occasional replacement and/or for the occasional replacement of rods. Lower level crossties will not have to be replaced. Their function is to help provide form and strength during the loading of soil. Because of the inertia of the placed soil at ground level, they become structurally redundant.

Each base level crosstie 520 is preferably passed below the underlay 420-1 and attached to the bottom horizontal wire at points opposite. Base level crossties can be installed before the textile liner 420 is installed. It is sufficient to space a base level crosstie approximately 1.2 metres from an end or from another base level crosstie in the preferred embodiments. A base level crosstie is attached by bending and looping one end of the crosstie around the bottom horizontal wire on a side of the perimeter wall and the other end of the crosstie around the bottom horizontal wire on the other side. The length of unbent wire between sides opposite is equal to the preferred width of the embodiment.

Each upper level crosstie 520 is preferably attached in a manner that takes advantage of the stiffness of the tensioning rods 310 interlaced with the horizontal wires of the mesh 220. In the absence of a tensioning rod 310, a similar rod placed on the outside of the wire mesh 220 and held in place by the end of a crosstie will help distributes pressure more effectively over a larger surface area than would occur if an upper level crosstie was attached directly to the wire mesh.

In the first embodiment, tensioning rods 310 on sides opposite are spaced approximately 600 mm apart. This spacing corresponds to an adequate spacing of upper level cross ties 520.

Each upper level crosstie 520 passes through the textile liner 420 on sides opposite next to a tensioning rod 310. From the liner, an end of each crosstie is brought past its corresponding tensioning rod 310. It is then brought across the back of the rod and bent towards the liner on the side of the rod opposite to where the crosstie emerges from the liner. It is then fixed to a mesh wire. The operation is repeated on the side opposite taking care to ensure the predetermined width of the embodiment.

To facilitate replacement as required of tensioning rods 310, or of their own replacement, care should be taken to not over twist the ends of the upper level crossties 520. To make assembly more efficient, crossties 520 are pre-cut to an adequate length and marked in a way that will speed their installation.

FIG. 2E also shows temporary post 510, which always has a counterpart along the wall opposite. A pair of posts 510 will be the same distance from an end. Each post 510 is temporarily embedded in the ground in a spot abutting the bottom horizontal wire on the outside of the planter. The alignment of the bottom horizontal wire can be first verified by extending a mason's line between the corner posts of its side, or by equivalent means. FIG. 2E also shows temporary brace 516, which is the width of the preferred embodiment. The posts and brace are a tool, which can be especially useful when assembling longer embodiments of the current invention. Used in conjunction with a level or a plumb bob, they provide a visual guide during loading of the soil. Posts 510 also help maintain the straightness of side walls.

FIG. 2F

FIG. 2F shows an example of the first embodiment with the soil 600 in place. The soil is preferably placed in successive lifts in the centre between the sides of the embodiment and brought manually to the sides. All temporary guys 116 are removed after soil placement. Any pair of temporary posts 510 and any temporary brace 516 are removed after soil placement. Liner clamping rods 410 are either removed or left in place to deteriorate.

FIG. 2G

FIG. 2G shows an example of the first embodiment with plants 700 established. Embodiments of the present invention can be maintained indefinitely. The entire structure can be renewed while the soil mass remains in place. Over time, a soil mass naturally gains internal structure, especially in the case of good soil management. Lateral earth pressure declines as friction within the soil mass increases. Moisture in the soil also adds to friction within the soil mass. It is to be noted that moisture in the soil will freeze when the ambient temperature is low enough. This provides a good, although not necessary, opportunity to easily replace any piece of the structure, except the crossties 520. Soil is displaced and crossties are checked occasionally for degradation. While they still retain sufficient tensile strength they can be replaced by attaching new crosstie to the old and pulling it into place through the previous holes and additional small cuts in the textile liner 420. There is no real need to remove a degraded mesh or liner, especially not the liner. A new liner and a new mesh can be installed over the old with only a small increase in wall thickness.

Advantages and Ramifications

Embodiments of the present invention are suitable for home and community gardening and for commercial agriculture in respect to crops which otherwise demand stoop labor. Their low cost, portability and ease of installation make them economically viable. The increased productivity of labour freed from stooping adds to this viability. Embodiments can be installed in locations with poor or no soil and have soil brought to them. Only a limited depth need be comprised of soil suitable for crops.

Embodiments with less height than the first embodiment may be preferable for varieties of taller plants. In situations such as schools where children are encouraged to learn about gardening, embodiments with less height and less width than the first embodiment may be preferred. Other embodiments can serve as a pre-existing barrier surrounding in some part homes or other buildings on flood plains. In this use they would be reinforced by sandbags to maintain their integrity against flood waters. They would, nonetheless, greatly reduce the amount of sandbagging required. In this flood defence role, they could also be gardened.

1. A high raised garden bed planter kit comprising a plurality of rods, textile, wire mesh, and single strand wire; wherein said rods, textile, wire mesh and wire are sufficient to form a continuous, rectangular, rigid, upright, perimeter wall of predetermined width, length, and height, which is impervious to soil; and wherein said rods hold said mesh under tension in a perimeter frame, and said textile lines said frame, and said wire is used to make attachments; whereby a person can work the surface of said planter with minimal or no stooping and can access the middle of the surface of said planter with minimal or no strain, and whereby the expensive, inherently rigid, predominant material of the prior art is replaced in great part by inexpensive, flexible materials with latent rigidity, and whereby the kit is lightweight and reasonably compact and relatively inexpensive, and whereby the planter can be assembled with a few widely available and inexpensive tools.

2. The raised garden bed kit of claim 1 wherein said rods are of substantially similar diameter.

3. The raised garden bed kit of claim 1 wherein said single strand wire is in one length long enough to be cut to suitable lengths in a quantity sufficient for all required attachments.

4. The raised garden bed kit of claim 1 and a plurality of wire staples to be used in the stead of some of said wire of claim 1 in making an attachment of said textile to said mesh.

5. A planter with a rectangular surface dimension for permanently maintaining a raised garden bed, wherein the height of said planter minimizes or eliminates stooping, and the width of said planter allows access to its middle from either side with minimal or no strain, and the length of said planter can equal its width or be many times longer than its width, comprising:
a lightweight perimeter wall comprised in great part of flexible materials, and
a means to maintain the rigidity of its length wise walls during and after the placement of soil, wherein one or a plurality of crossties are used to enable the lateral earth pressure pushing against one side to resist the lateral earth pressure pushing against the side opposite.

6. A method to construct an upright, rectangular, planter of pre-determined dimensions comprising a plurality of rods, textile, wire mesh and single strand wire wherein:
some of said rods are used as corner posts and are braced by others of said rods and are held in predetermined, fixed positions defining the length and width of an embodiment, and some of said wire is used to make attachments as required;
corners are formed at pre-determined intervals along the length of said wire mesh and said mesh is attached with some of said wire and others of said rods to said corner posts and joined at its ends to form a continuous, reasonably rigid, rectangular, upright frame;
others of said rods are interlaced vertically through said mesh such that some horizontal wires of said mesh are on one side of said rods and some horizontal wires of said mesh are on the other side of said rods and wherein the top horizontal wire of said mesh is pushed up by an end of each of said rods and the bottom horizontal wire of said mesh is held down by the other end of each of said rods, whereby the rigidity of said frame is augmented;
said textile is extended until it forms a continuous inside liner with overlapping ends that are joined with some of said wire, and a narrow band of said textile is folded over the top horizontal wire of said mesh and attached to itself with wire in the manner of a hem, whereby said textile is restrained;
a band of said textile sufficiently wide to be held to the ground by and during the placement of soil is extended inwards from the base of said perimeter wall;
some of said wire is made into one or a plurality of crossties of a predetermined length and in one or a plurality of units is attached to sides opposite of the embodiment at an appropriate height or heights and with appropriate horizontal spacing, whereby the predetermined width of the embodiment is maintained and the lateral earth pressure against a side can be used to resist the lateral earth pressure against the side opposite.

7. The method of claim 6 and the parts of said claim plus a plurality of wire staples to be used in the stead of some of said wire of said claim in making the attachment of said textile of said claim to the top horizontal wire of said mesh of said claim.
